(19) United States
(12) Patent Application Publication
(10) Pub. No.: US 2016/0136469 A1
(43) Pub. Date: May 19, 2016

(54) Bottle Type Fire Extinguisher Structure

(71) Applicant: TSUNG-I LIN, Taichung City (TW)

(72) Inventor: TSUNG-I LIN, Taichung City (TW)

(21) Appl. No.: 14/681,074

(22) Filed: Apr. 7, 2015

(30) Foreign Application Priority Data
Nov. 14, 2014 (TW) 103220188

(51) Int. Cl. A62C 13/64

(52) U.S. Cl. CPC A62C 13/64

(57) ABSTRACT

A bottle type fire extinguisher structure includes a high-pressure aluminum bottle. A seal cover of the high-pressure aluminum bottle is provided with a positioning disc. The positioning disc has engaging blocks for engagement of the seal cover. The seal cover is provided with a press control head having a flared nozzle. The upper end of the positioning disc is provided with a cap to cover the press control head. The cap has an opening and a notch. The inner surface of the cap is provided with an annular protruding rib to be fitted to the positioning disc, such that the cap and the positioning disc are assembled together. There is no need to open he cap. The user's finger passes the notch to press the press control head, the fire-extinguishing chemical is sprayed out through opening. Through the flared nozzle, the fire-extinguishing chemical can be sprayed further and aimed at the fire exactly to put out the fire instantly.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a bottle type fire extinguisher structure, and more particularly to a fire extinguisher structure applied to a high-pressure aluminum bottle to put a fire out instantly and to aim at the fire exactly.

2. Description of Related Arts

As shown in FIG. 1 to FIG. 4, a conventional bottle type fire extinguisher is made of aluminum ingot and formed by extrusion to be a high-pressure aluminum bottle 10, without an edge sealing. The opening of the upper end is reduced. A seal cover 11 is formed with a riveting edge 111. The upper end of the seal cover 11 is coupled with a press control head 12 having a nozzle 121. A cylindrical cap 13 is provided to cover the press control head 12. The cap 13 comprises a plurality of elastic engaging plates 14 corresponding to the outer wall of the seal cover 11. The end edge of each engaging plate 14 is provided with an engaging hook 15 in the central direction to engage with the riveting edge 111 of the seal cover 11, such that the cap 13 is secured to the high-pressure aluminum bottle 10. However, the aforesaid structure has some shortcomings.

1. When in use, the user has to open the cap 13 first and then to press the press control head 12. This is inconvenient to use. When the cap 13 is opened by applying a force and the force is not controlled well, at the moment that the engaging hooks 15 disengage from the riveting edge 111, the cap 13 is slid along the smooth bottle body, and the engaging hooks 15 may pull up the press control head 12 by mistake, as shown by the broken lines of FIG. 4. It takes time to look for the press control head 12. This is unable to put out the fire immediately. When the situation is urgent, the press control head 12 can't be found instantly to cause serious casualties.

2. The nozzle 121 of the fire extinguisher is in the shape of circle. The fire-extinguishing chemical is sprayed in the form of fog. This way cannot aim at the fire exactly, so the effect to put out the fire is not good.

3. After the fire extinguisher is used, it takes time to look for the cap 13. If the cap 13 is lost, the press control head 12 may be pressed by mistake to spray the fire-extinguishing chemical.

Accordingly, the inventor of the present invention has devoted himself based on his many years of practical experiences to solve this problem.

### SUMMARY OF THE PRESENT INVENTION

The primary objective of the present invention is to provide a bottle type fire extinguisher structure to solve the aforesaid problems, which is more convenient and safe.

The bottle type fire extinguisher structure includes a high-pressure aluminum bottle. A seal cover of the high-pressure aluminum bottle is provided with a positioning disc. A cap is fitted on the positioning disc. The cap has an opening and a notch. There is no need to open the cap. Through the notch, the user can press a press control head to spray the fire-extinguishing chemical through the opening.

Preferably, the press control head has a flared nozzle. When the press control head is pressed by applying a force, the fire-extinguishing chemical is sprayed out through the flared nozzle, such that the fire-extinguishing chemical can be sprayed further and aimed at the fire exactly to put out the fire instantly.

### BRIEF DESCRIPTION OF THE DRAWINGS

FIG. 1 is an exploded view of a conventional high-pressure aluminum bottle fire extinguisher;

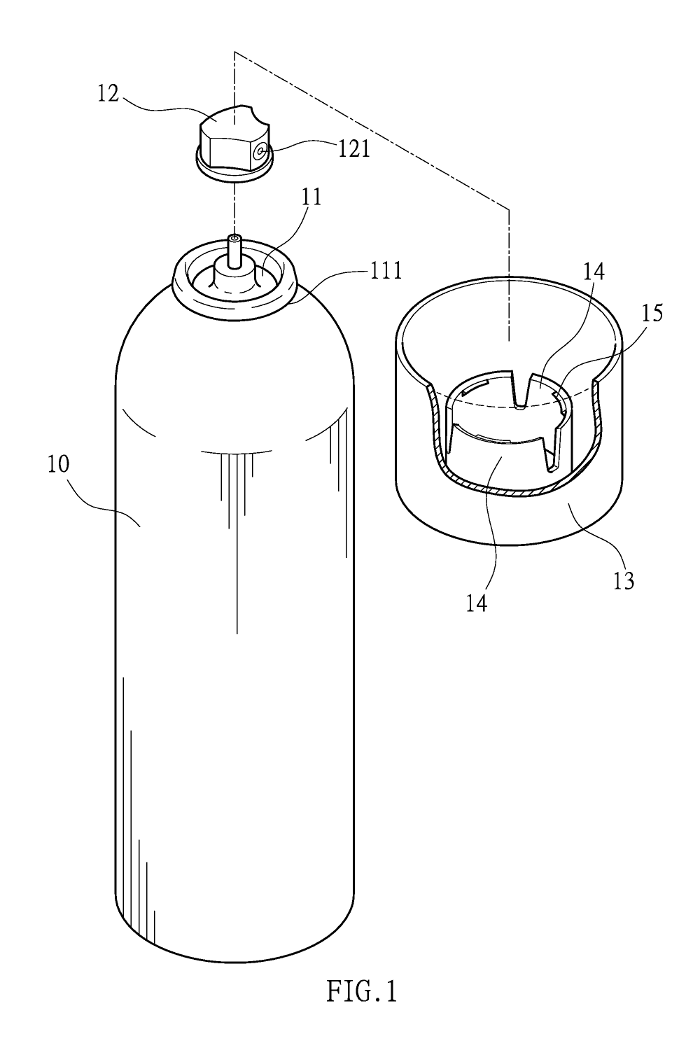

FIG. 2 is a perspective view of the conventional high-pressure aluminum bottle fire extinguisher;

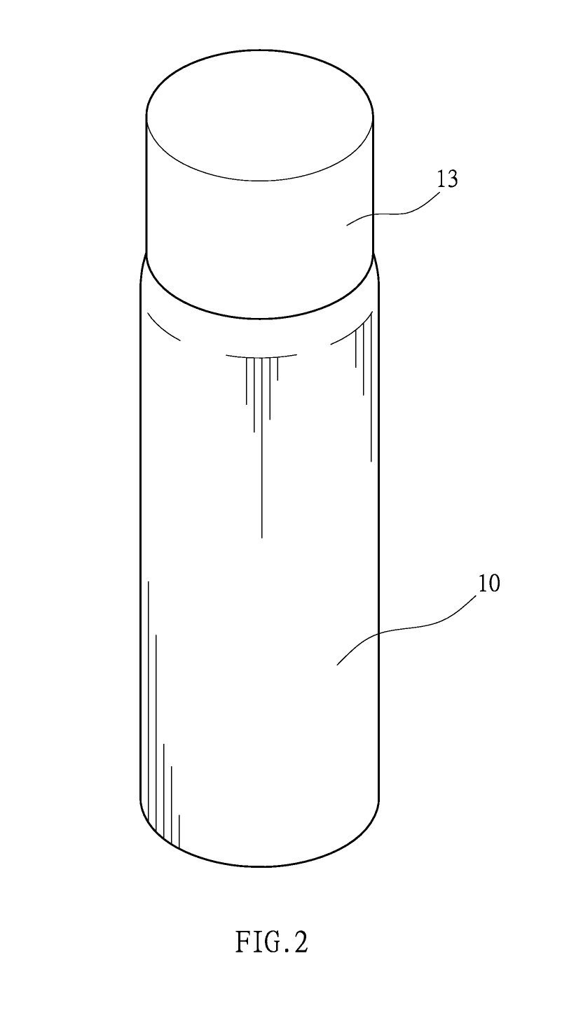

FIG. 3 is a side sectional view of a conventional cap in a closed state;

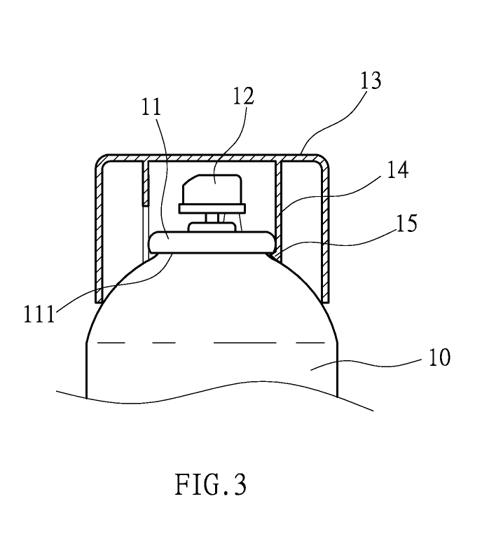

FIG. 4 is a side sectional view of the conventional cap when in use;

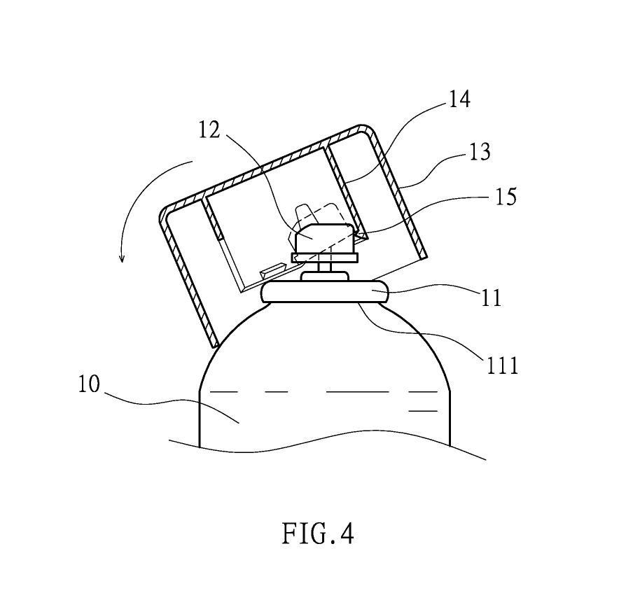

FIG. 5 is an exploded view of the present invention;

FIG. 6 is an exploded view of the present invention mounted on a high-pressure aluminum bottle;

FIG. 7 is a schematic view of the present invention coupled with a press control head;

FIG. 8 is a perspective view of the present invention mounted on the high-pressure aluminum bottle; and

FIG. 9 is a side sectional view of the present invention when in use.

### DETAILED DESCRIPTION OF THE PREFERRED EMBODIMENT

Embodiments of the present invention will now be described, by way of example only, with reference to the accompanying drawings.

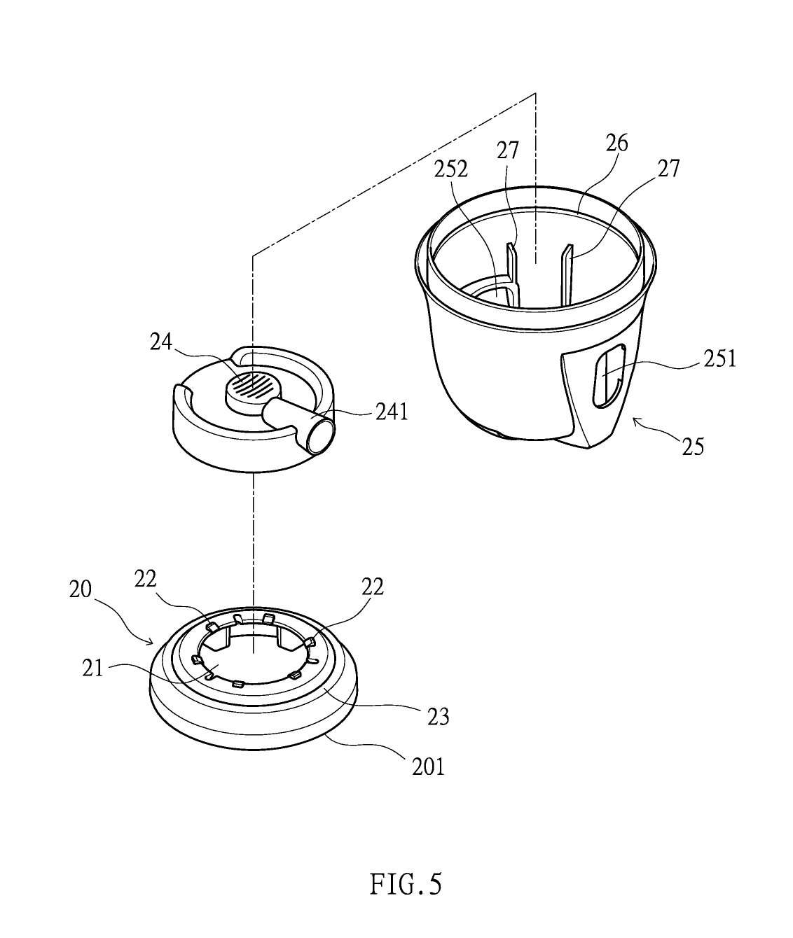

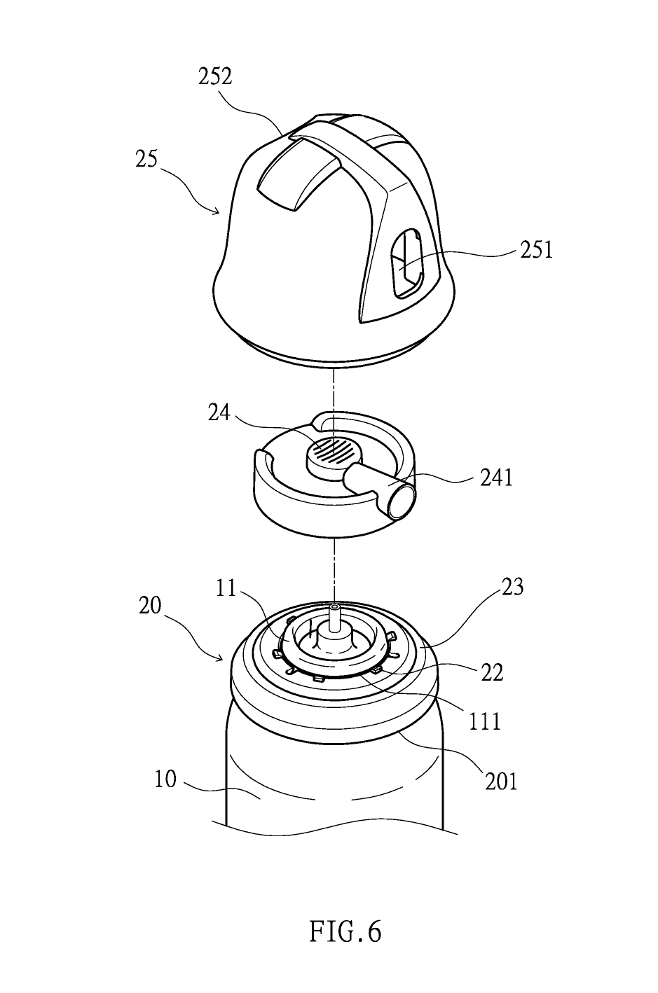

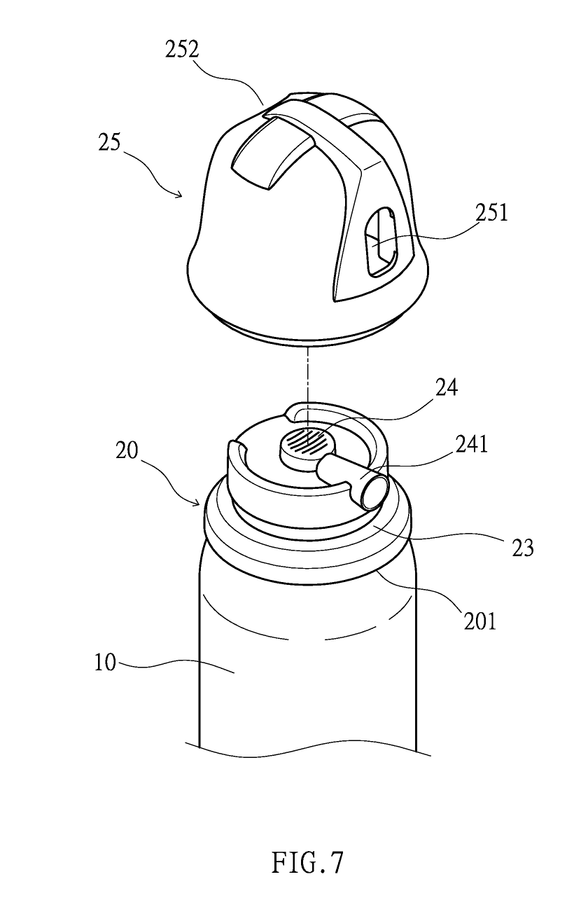

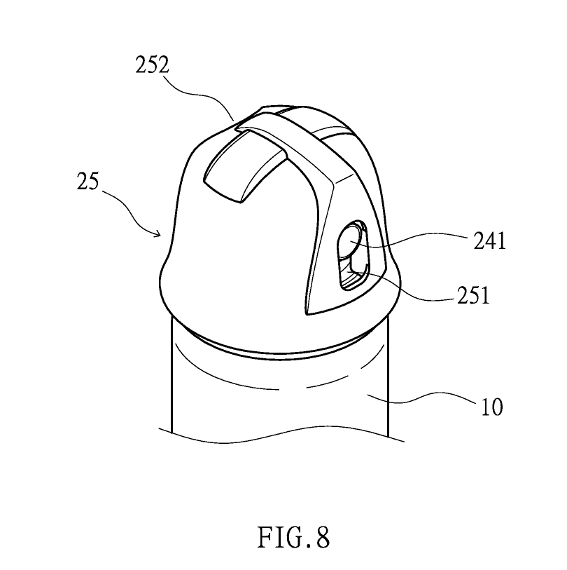

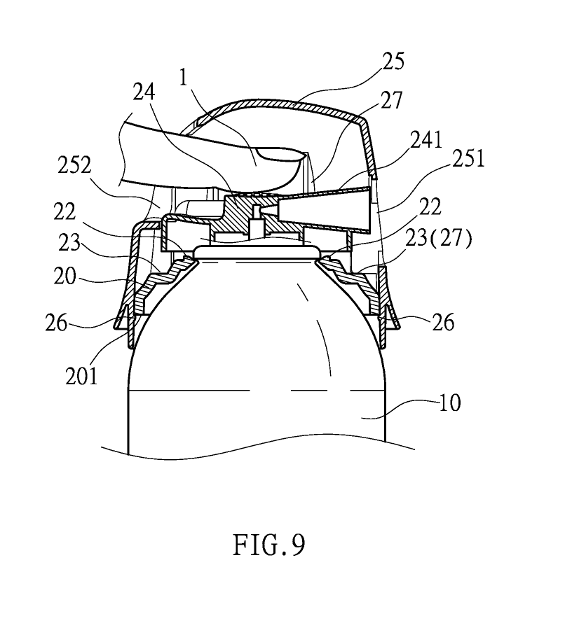

As shown in FIG. 5 to FIG. 9, a riveting edge 111 of a seal cover 11 of a high-pressure aluminum bottle 10 is engaged with a positioning disc 20. The positioning disc 20 has a central through hole 21, an annular limit edge 23 around an outer periphery thereof, a bottom edge 201 at a bottom thereof, and at least three engaging blocks 22 on an inner circumferential edge of the through hole 21. The engaging blocks 22 are toothed and slightly extend out of the through hole 21 to hold against the bottom of the riveting edge 111, such that the positioning disc 20 is secured to the seal cover 11 of the high-pressure aluminum bottle 10. A press control head 24 having a flared nozzle 241 is provided on top of the seal cover 11. A cap 25 having an opening 251 and a notch 252 is provided to cover the positioning disc 20. The flared nozzle 241 is inserted in the opening 251 and movable up and down. The cap 25 is provided with vertical positioning plates 27 and an annular protruding rib 26 therein. The positioning plates 27 holds against the limit edge 23, and the annular protruding rib 26 holds against the bottom edge 201 of the positioning disc 20. Through the aforesaid structure, there is no need to open the cap for use. The user can press the press control head 24 through the notch 252 to put a fire out.

The details to manufacture the present invention are described hereinafter. The high-pressure aluminum bottle 10 is formed by extrusion to be a smooth bottle, without seams and sealing edges. Thus, any position of the bottle body is unable to engage with other parts, except the seal cover 11 and the riveting edge 111 as a choice of engagement. In order to achieve the objective to use the fire extinguisher without opening the cap, the positioning disc 20 made of a plastic material is fitted to the seal cover 11. The through hole 21 of the positioning disc 20 corresponds in size to the seal cover 11 to be fitted. When the seal cover 11 passes through the through hole 21 by applying a force, the toothed engaging blocks 22 are deformed elastically for the seal cover 11 to pass therethrough. After pass, the engaging blocks 22 are restored to engage the riveting edge 111 so as to secure the positioning disc 20.

On the contrary, when the user wants to disengage the positioning disc 20 from the engaging blocks 22, the user just applies a greater force to elastically deform the engaging blocks 22 for disengagement.

The cap 25 is made of a plastic material. The inner diameter of the cap 25 corresponds to the outer diameter of the positioning disc 20. When the cap 25 is fitted to the positioning disc 20, the protruding rib 26 passes the bottom edge 201 of the positioning disc 20 by applying a greater force to elastically deform the rib 26 so as to pass the bottom edge 201. The positioning plates 27 of the cap 25 hold against the limit edge 23 of the positioning disc 20 to position the cap 25 steady, and the protruding rib 26 is engaged with the bottom edge 201, so the cap 25 won't disengage from the positioning disc 20. On the contrary, when the user wants to open the cap 25, he/she just applies a greater force to elastically deform the protruding rib 26 again for disengagement. Accordingly, the present invention is assembled easily and very convenient for use and very practical. The positioning disc 20 assists the cap 25 in positioning, without being fitted to the seal cover 11, such that the flared nozzle 241 of the press control head 24 can extend out of the opening 251. The opening 251 is greater for the press control head 24 to move up and down. The user can stretch his/her finger 1 into the notch 252 to press the press control head 24. In case there is a fire, the user can immediately use the fire extinguisher without opening the cap 25 to put out the fire instantly so as to lower the damage and casualty.

The present invention has the following effects and advantages:

1. There is no need to use an additional tool for assembly to achieve convenient and practical effects.

2. When in use, the user stretches his/her finger 1 into the notch 252 to press the press control head 24, without opening the cup 25, so the press control head 25 won't fall and be lost. The fire extinguisher can be used promptly and conveniently.

3. The fire-extinguishing chemical is sprayed out through the flared nozzle 241. This way can spray the fire-extinguishing chemical further and aims at the fire exactly to put out the fire. It is unnecessary for the user to approach the fire to put it out. The present invention is safe for use.

4. There is no need to open the cap 25 for using the fire extinguisher, so the cap 25 won't be lost to protect the press control head 25 from touching by accident

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bottle type fire extinguisher structure, comprising:
a high-pressure aluminum bottle comprising a seal cover having a riveting edge and being provided with a press control head having a flared nozzle;
a positioning disc wherein the riveting edge of the seal cover of the high-pressure aluminum bottle is engaged with the positioning disc, wherein the positioning disc has a central through hole and at least three engaging blocks on an inner circumferential edge of the through hole, wherein the engaging blocks are toothed and slightly extending out of the through hole to hold against a bottom of the riveting edge for securing the positioning disc to the seal cover of the high-pressure aluminum bottle, and
a cap, which is provided to cover the positioning disc, having an opening and a notch, wherein the flared nozzle is inserted in the opening and movable up and down, thereby, through the notch, a user can press the press control head without opening the cap.

2. The bottle type fire extinguisher structure as claimed in claim 1, wherein the positioning disc has an annular limit edge around an outer periphery thereof and a bottom edge at a bottom thereof, wherein an inner surface of the cap is provided with vertical positioning plates and an annular protruding rib, wherein the positioning plates holds against the limit edge, wherein the annular protruding rib holds against the bottom edge of the positioning disc.
